(19) United States
(12) Patent Application Publication
(10) Pub. No.: US 2025/0021455 A1
(43) Pub. Date: Jan. 16, 2025

(54) TEST SUPPORT APPARATUS AND TEST SUPPORT METHOD

(71) Applicant: Hitachi, Ltd., Tokyo (JP)

(72) Inventors: Jumpei OKOSHI, Tokyo (JP); Yohsuke ISHII, Tokyo (JP); Tatsuhiko MIYATA, Tokyo (JP)

(21) Appl. No.: 18/605,543

(22) Filed: Mar. 14, 2024

(30) Foreign Application Priority Data
Jul. 13, 2023 (JP) 2023-114960

(51) Int. Cl. G06F 11/263

(52) U.S. Cl. CPC G06F 11/263

(57) ABSTRACT

Based on a state transition table of each of individual services and a state transition correspondence table that shows the correspondence relationship between a state transition in each individual service and a trigger event that triggers a state transition of another individual service caused by that state transition, a test scenario generation portion 15 generates a test scenario indicating a state transition pattern of a test target service and a state transition pattern of a coupling destination service that occurs in conjunction with that state transition pattern. A stateful pact generation portion 16 generates a stateful pact describing a response of the coupling destination service that takes into account the transition pattern of the coupling destination service. Based on the test scenario and the stateful pact, a test program generation portion 17 generates a pact test program, which is a program for conducting a test.

### CROSS-REFERENCE TO PRIOR APPLICATION

This application relates to and claims the benefit of priority from Japanese Patent Application No. 2023-114960 filed on Jul. 13, 2023 the entire disclosure of which is incorporated herein by reference.

### BACKGROUND

The present disclosure relates to a test support apparatus and a test support method.

When developing or updating a system such as a service-providing system for providing a service, for example, it is important to test whether the service operates normally. However, in recent years, services have become larger and more complex and difficult to conduct appropriate tests.

In this respect, Japanese Patent Application Publication No. 2020-9271 discloses a verification information generation apparatus that generates a test case, which is verification information used to test a service. This verification information generation apparatus uses state transition pair information, which associates the states of service and the transitions that are feasible from those states, thereby selecting transitions with high transition frequency, and generating a test case using the selected transitions. This allows a test of the service to be conducted efficiently.

In recent years, a technique called MSA (Microservice Architecture) has been attracting attention as a technique of system development. In MSA, one service is constructed from a collection of multiple individual services, i.e., also called microservices, having different functions. This enables the parallelization of system development, for example.

However, at the stage of system development, the correspondence relationship between the state transition of an individual service to be tested and the state transition of another individual service linked to that individual service is not obvious. The technology described in Japanese Patent Application Publication No. 2020-9271 does not take into account a situation where multiple services cooperate to form one service, such as with MSA, and merely uses state transition pair information that associates the states of one service and transitions. For this reason, when multiple services cooperate to construct one service, tests cannot be conducted efficiently.

### SUMMARY

It is an object of the present disclosure to provide a test support apparatus and a test support method that can easily conduct a test even when a service is composed of a plurality of individual services.

A test support apparatus according to one aspect of the present disclosure is a test support apparatus for supporting a test regarding maintenance of data integrity in a predetermined service composed of a plurality of individual services, the test support apparatus including: a scenario generation portion configured to generate, on the basis of state transition information indicating a state transition that occurs in each of the plurality of individual services and correspondence information indicating a correspondence relationship between a state transition in each of the plurality of individual services and a trigger event that triggers a state transition of another of the individual services caused by the state transition, a test scenario indicating a target transition pattern that is a pattern of state transition of a target service that is any of the plurality of individual services, and a coupling destination transition pattern of state transition of a coupling destination service that is one of the individual services different from the target service that occur in conjunction with the target transition pattern; a pact generation portion configured to generate a stateful pact that is a pact that defines a response of the coupling destination service that takes into account the coupling destination transition pattern based on the test scenario; and a program generation portion configured to generate, on the basis of the test scenario and the stateful pact, a pact test program that is a program for conducting the test.

According to the present invention, a test can be easily conducted even when a service is composed of multiple individual services.

### BRIEF DESCRIPTION OF THE DRAWINGS

FIG. 1 is a diagram showing an example of the functional configuration of a test support apparatus;

FIG. 2 is a diagram showing an example of the hardware configuration of the test support apparatus;

FIG. 3 is a diagram showing an example of a state transition table editing screen;

FIG. 4 is a diagram showing an example of a state transition correspondence table editing screen;

FIG. 5 is a flowchart illustrating an example of test support processing;

FIG. 6 is a diagram illustrating an example of data relating to the test support processing;

FIG. 7 is a flowchart illustrating an example of test scenario expansion processing;

FIG. 8 is a diagram illustrating an example of data relating to the test scenario expansion processing;

FIG. 9 is a flowchart illustrating an example of measure presentation processing;

FIG. 10 is a diagram illustrating an example of data relating to the measure presentation processing; and

FIG. 11 is a diagram illustrating an example of processing for generating a state transition correspondence table.

### DETAILED DESCRIPTION OF THE EMBODIMENT

Referring to the drawings, embodiments of the present disclosure are described below.

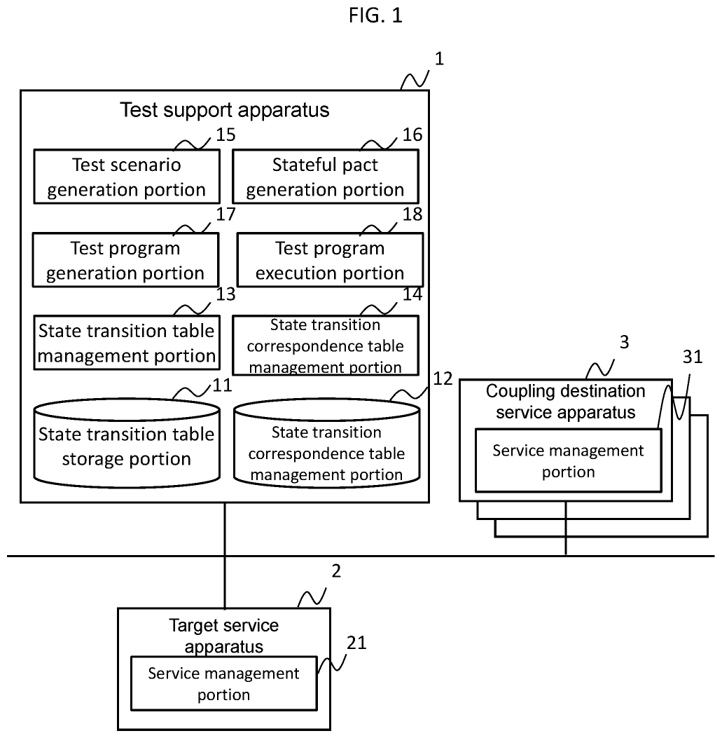

FIG. 1 is a diagram showing an example of the functional configuration of a test support apparatus according to an embodiment of the present disclosure. A test support apparatus 1 shown in FIG. 1 is an apparatus that supports a test on a system for providing a predetermined service and is communicably coupled to a target service apparatus 2 and a coupling destination service apparatus 3. The test of this embodiment is a test regarding the maintenance of data integrity. There may be multiple coupling destination service apparatuses 3.

The target service apparatus 2 and the coupling destination service apparatus 3 form a system that provides a predetermined service. In this embodiment, the system is constructed with MSA. In other words, the system, or more specifically the services provided by the system, are composed of a collection of multiple individual services, also called microservices. The target service apparatus 2 is the apparatus that provides a test target service to be tested by the test support apparatus 1 among multiple individual services forming the system, and the coupling destination service apparatus 3 is the apparatus that provides a coupling destination service that is another individual service different from the test target service among the multiple services forming the system. The target service apparatus 2 has a service management portion 21 that manages the test target service, and the coupling destination service apparatus 3 has a service management portion 31 that provides the coupling destination service.

The test support apparatus 1 includes a state transition table storage portion 11, a state transition correspondence table storage portion 12, a state transition table management portion 13, a state transition correspondence table management portion 14, a test scenario generation portion 15, and a stateful pact generation portion 16, a test program generation portion 17, and a test program execution portion 18.

The state transition table storage portion 11 stores a state transition table for each of multiple individual services. The state transition table is state transition information indicating the state transition of the individual service, and more specifically, it shows the correspondence relationship between a possible state of the individual service, another state to which that state transitions and a trigger event that triggers the transition.

The state transition correspondence table storage portion 12 stores a state transition correspondence table regarding multiple individual services. The state transition correspondence table is correspondence information indicating the correspondence relationship between a state transition in each of multiple individual services and a trigger event that triggers a state transition of the coupling destination service caused by that state transition.

The state transition table management portion 13 manages the state transition tables stored in the state transition table storage portion 11. For example, the state transition table management portion 13 receives a state transition table from a user who uses the test support apparatus 1 and stores it in the state transition table storage portion 11.

The state transition correspondence table management portion 14 is a correspondence information management portion that manages the state transition correspondence table stored in the state transition correspondence table storage portion 12. For example, the state transition correspondence table management portion 14 receives a state transition correspondence table from a user and stores it in the state transition correspondence table storage portion 12.

The test scenario generation portion 15 generates, based on the state transition table stored in the state transition table storage portion 11 and the state transition correspondence table stored in the state transition correspondence table storage portion 12, a test scenario that indicates a state transition pattern of the test target service (target transition pattern) and a state transition pattern of the coupling destination service that is associated with that state transition pattern (coupling destination transition pattern).

Based on the test scenario generated by the test scenario generation portion 15, the stateful pact generation portion 16 generates a stateful pact, which is a pact describing the behavior (response) of the coupling destination service taking into account the state transition pattern of the coupling destination service.

The test program generation portion 17 generates, based on the test scenario generated by the test scenario generation portion 15 and the stateful pact generated by the stateful pact generation portion 16, a test program (pact test program), which is a program for conducting a test regarding the maintenance of data integrity of the test target service.

The test program execution portion 18 conducts a test by executing the test program generated by the test program generation portion 17, and presents, based on the test conduction result, which is the result of the test, a measure regarding modification of the program for providing the test target service.

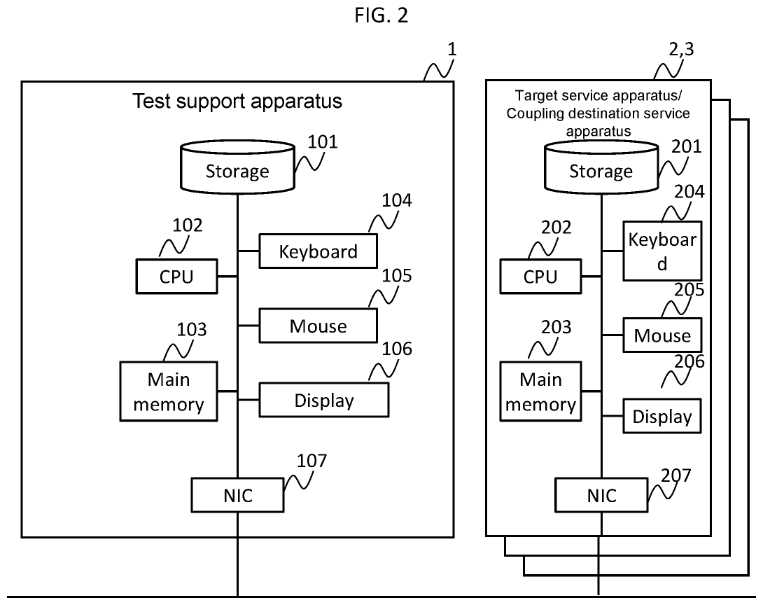

FIG. 2 is a diagram showing an example of the hardware configuration of the test support apparatus 1. As shown in FIG. 2, the test support apparatus 1 includes a storage 101, a CPU (Central Processing Unit) 102, a main memory 103, a keyboard 104, a mouse 105, a display 106, and a NIC (Network Interface Card) 107.

The storage 101 is a recording apparatus that records data in a writable and readable manner, and records programs that define the operation of the CPU 102 and various information used and generated by the programs. The CPU 102 is an example of a processor and performs various functions by reading a program recorded in the storage 101 into the main memory 103 and executing it using the main memory 103. In this embodiment, the storage 101 or the main memory 103 implements the state transition table storage portion 11 and the state transition correspondence table storage portion 12, and the CPU 102 implements the other portions (13 to 18) of the test support apparatus.

The keyboard 104 and the mouse 105 form an input apparatus for receiving various types of information from the user. The display 106 is a display apparatus that displays various types of information. The NIC 107 is a communication apparatus that is communicably coupled to the target service apparatus 2 and the coupling destination service apparatus 3, which are external apparatuses.

Like the test support apparatus 1, the target service apparatus 2 and the coupling destination service apparatus 3 have a storage 201, a CPU 202, a main memory 203, a keyboard 204, a mouse 205, a display 206, and a NIC 207.

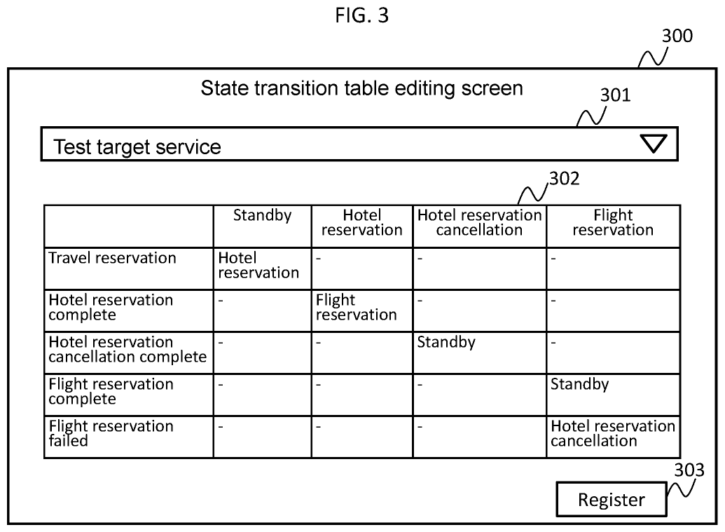

FIG. 3 is a diagram showing an example of a state transition table editing screen for the user to input and edit a state transition table. The state transition table editing screen 300 shown in FIG. 3 is a screen displayed by the state transition table management portion 13 and includes a service selection field 301, an edit field 302, and a registration button 303.

The service selection field 301 is an interface for selecting, as the editing target service, an individual service whose state transition table is to be input or edited. In the example of FIG. 3, the test target service is selected as the editing target service. The edit field 302 is an interface for editing the state transition table of the editing target service selected in the service selection field 301, and the example in FIG. 3 shows the state transition table after editing. The registration button 303 is an interface for registering the state transition table input or edited in the edit field 302. When the registration button 303 is pressed, the state transition table management portion 13 stores the state transition table input or edited in the edit field 302 in the state transition table storage portion 11.

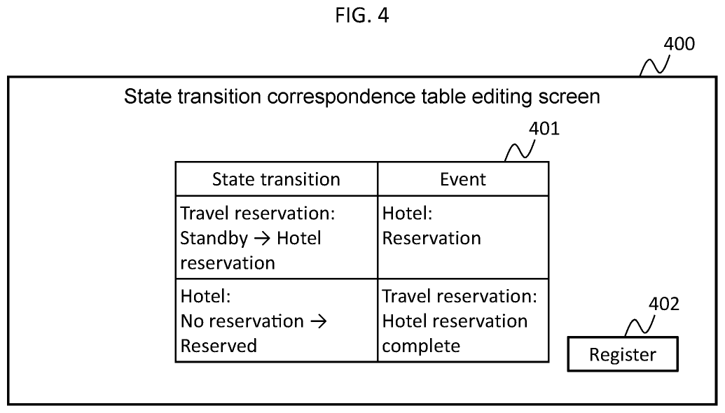

FIG. 4 is a diagram showing an example of a state transition correspondence table editing screen for the user to input and edit the state transition correspondence table. A state transition correspondence table editing screen 400 shown in FIG. 4 is a screen displayed by the state transition correspondence table management portion 14 and includes an edit field 401 and a registration button 402.

The edit field 401 is an interface for inputting or editing the state transition correspondence table, and the example in FIG. 4 shows the state transition correspondence table after editing. The registration button 402 is an interface for registering the state transition correspondence table input or edited in the edit field 401. When the registration button 402 is pressed, the state transition correspondence table management portion 14 stores the state transition correspondence table input or edited in the edit field 401 in the state transition correspondence table storage portion 12.

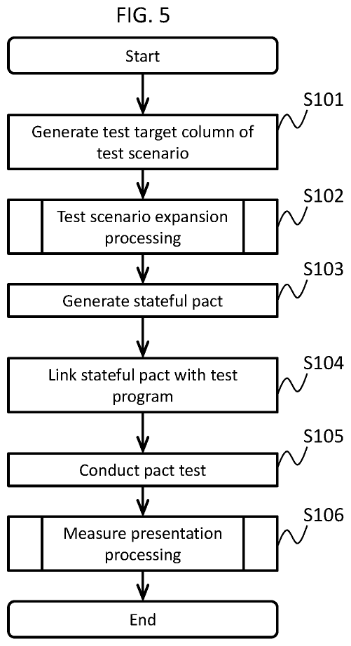

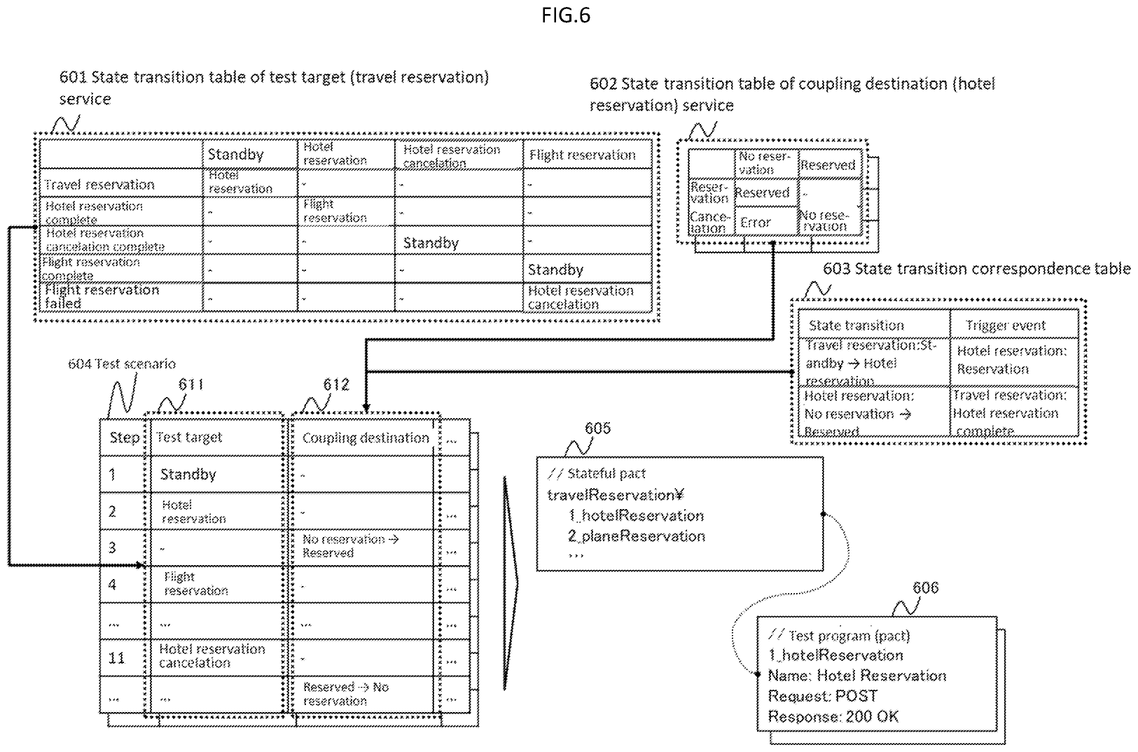

FIG. 5 is a flowchart illustrating an example of test support processing performed by the test support apparatus 1, and FIG. 6 is a diagram illustrating an example of data relating to the test support processing.

In the examples shown in FIGS. 5 and 6, the test target service is a travel reservation service, and the coupling destination service is a hotel reservation service. As shown in FIG. 6, a state transition table 601 of the test target service (travel reservation service) and a state transition table 602 of the coupling destination service (hotel reservation service) are registered in advance as state transition tables in the state transition table storage portion 11, and a state transition correspondence table 603 is registered as the state transition correspondence table in the state transition correspondence table storage portion 12.

In the state transition tables (601, 602) shown in FIG. 6, the column represents states before transition, the row represents trigger events that trigger state transitions, and a field at which a row and a column intersect contains the state after the state corresponding to the column transitions due to the trigger event corresponding to the row. For example, in the state transition table 601, when the state is “Standby” and the trigger event “Travel reservation” occurs, the state transitions to “Hotel reservation”. In the state transition table 602, when the state is “No reservation” and the trigger event “Reservation” occurs, the state transitions to “Reserved”.

Furthermore, the state transition correspondence table 603 shown in FIG. 6 shows the correspondence relationship between a state transition of an individual service and a trigger event that triggers a state transition of another individual service caused by that state transition. Specifically, the state transition correspondence table 603 shows that when a state transition occurs in the travel reservation service (Travel reservation) from “Standby” to “Hotel reservation”, the trigger event “Reservation” occurs in the hotel reservation service (Hotel reservation). The state transition correspondence table 603 also shows that when a state transition occurs in the hotel reservation service from “No reservation” to “Reserved”, the trigger event “Hotel reservation complete” occurs in the travel reservation service.

In the test support processing, as shown in FIG. 5, the test scenario generation portion 15 first identifies the possible state transition pattern of the test target service based on the state transition table 601 of the test target service stored in the state transition table storage portion 11, and generates a test scenario 604 including a test target column 611 representing that state transition pattern (step S101). When there are multiple state transition patterns, the test scenario generation portion 15 may generate a test scenario 604 for each state transition pattern. As such, the test scenario generation portion 15 generates one or more test scenarios 604.

Then, based on the state transition table 602 regarding the coupling destination service stored in the state transition table storage portion 11 and the state transition correspondence table 603 stored in the state transition correspondence table storage portion 12, the test scenario generation portion 15 performs test scenario expansion processing, which adds to the test scenario 604 a coupling destination column 612 representing the state transition pattern of the coupling destination service that occurs in conjunction of the state transition pattern represented by the test target column 611 (step S102). When there are multiple state transition patterns of the coupling destination service that occur in conjunction with the state transition pattern represented by the test target column 611, multiple test scenarios 604 to which coupling destination columns are added are generated for the respective state transition patterns of the coupling destination service.

Then, the stateful pact generation portion 16 extracts the test target column 611 from the test scenario 604, and, based on the test target column 611, generates a stateful pact 605 describing the response of the coupling destination service that takes into account the state transition pattern of the coupling destination service (step S103). The stateful pact 605 is a pact that involves state transition. Specifically, it is a pact that performs a prespecified response and changes the state (that is, the response content) according to the state transition pattern.

Furthermore, for each test scenario 604, the test program generation portion 17 generates a test program 606, which is a program for conducting a test according to the test scenario, and generates a pact test program by linking the test program 606 with the stateful pact 605 (step S104).

The test program execution portion 18 then executes the pact test program (the test program 606 linked to the stateful pact 605) to conduct a pact test on the test target service (step S105).

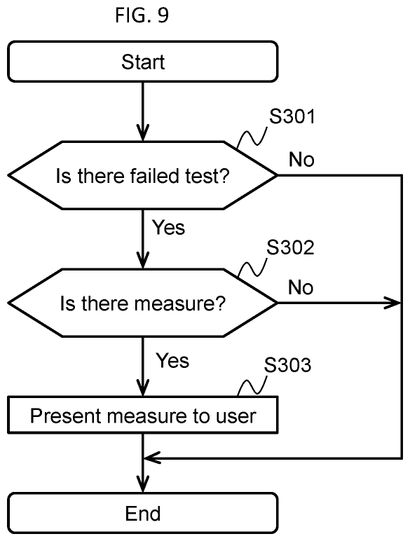

Then, based on the test conduction result, which is the result of the pact test, the test program execution portion 18 performs measure presentation processing (see FIG. 9) that presents a measure to the user (step S106), and ends the processing.

In the above processing, the state transition correspondence table may further indicate the correspondence relationship between a state transition in each of the multiple individual services and an occurrence event that occurs due to the state transition. In this case, the test scenario generation portion 15 expands the test scenario 604 taking into account the occurrence event in the test scenario expansion processing at step S102.

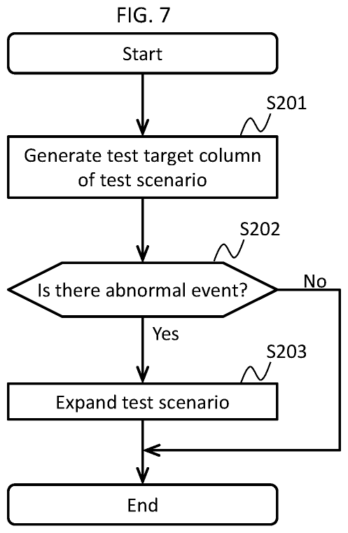

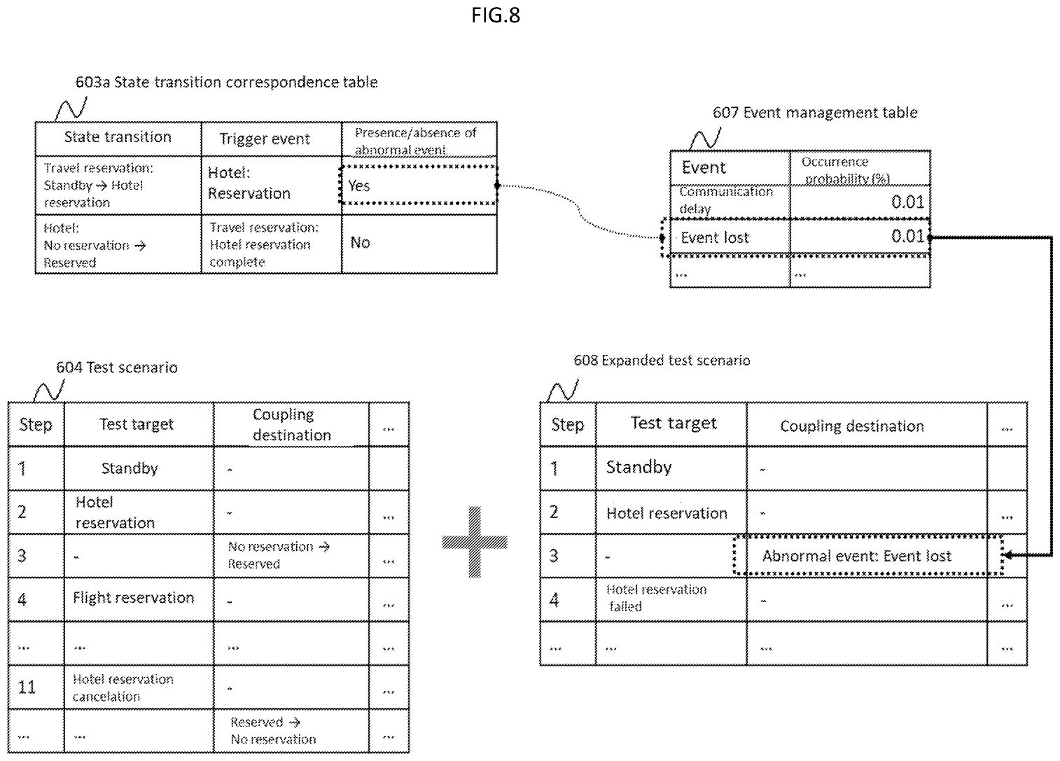

FIG. 7 is a flowchart illustrating an example of test scenario expansion processing including processing for expanding the test scenario 604 taking into account occurrence events, and FIG. 8 is a diagram illustrating an example of data relating to the test scenario expansion processing. In FIGS. 7 and 8, the occurrence events are abnormal events.

As shown in FIG. 8, in a state transition correspondence table 603a used when abnormal events are taken into account, information showing the presence or absence of the possibility of occurrence of an abnormal event caused by the state transition of the individual service (Presence/absence of abnormal event) is added to the state transition correspondence table 603 shown in FIG. 6. In addition, the state transition correspondence table storage portion 12 further stores an event management table 607 that shows, for each abnormal event type, the probability of occurrence of an abnormal event of that abnormal event type.

In the test scenario expansion processing, as shown in FIG. 7, the test scenario generation portion 15 generates, based on the state transition table 602 regarding the coupling destination service and the state transition correspondence table 603a, adds to the test scenario 604 a coupling destination column 612 representing the state transition pattern of the coupling destination service that occurs in conjunction with the transition pattern represented by the test target column 611 (step S201).

The test scenario generation portion 15 then determines, based on the state transition correspondence table 603a, whether there is a possibility that an abnormal event occurs in the transition pattern of the test scenario 604 (step S202).

If there is a possibility that an abnormal event occurs (step S202: Yes), the test scenario generation portion 15 generates, as a new test scenario, an expanded test scenario 608 that is generated by expanding the test scenario 604 to include the state transition pattern for a situation where the abnormal event shown in the event management table 607 occurs (step S203), and ends the processing. In contrast, if there is no possibility that an abnormal event occurs (step S202: No), the test scenario generation portion 15 skips step S203 and ends the processing.

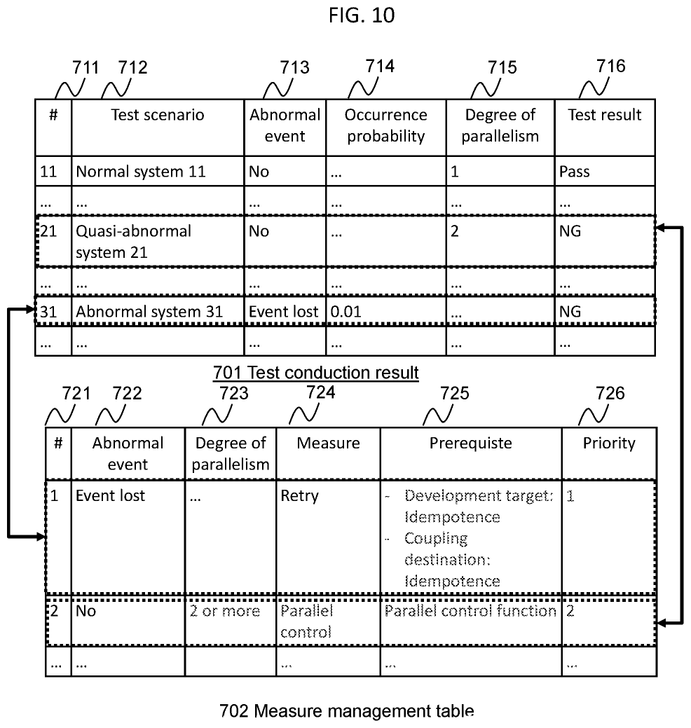

FIG. 9 is a flowchart showing an example of the measure presentation processing at step S106 in FIG. 5, and FIG. 10 is a diagram illustrating an example of data relating to the measure presentation processing.

As shown in FIG. 10, assume that a test conduction result 701 is generated as a test conduction result, which is the result of a pact test. The test conduction result 701 indicates, for each identification number (#) 711 that specifies a test scenario 604, the name 712 of the test scenario 604, the presence or absence of an abnormal event 713 in the test scenario 604, the probability of occurrence of an abnormal event 714, the degree of parallelism 715 in the test scenario 604, and the test result 716 of a pact test according to the test scenario 604. The test result 716 indicates “Pass” when the pact test is successful, and indicates “NG” when the pact test fails.

Additionally, a measure management table 702 is prepared in advance. The measure management table 702 may be registered in advance in the state transition table storage portion 11, the state transition correspondence table storage portion 12, or another storage portion (not shown), for example. The measure management table 702 shows, for each identification number 721 that specifies a measure, the type 722 of the abnormal event included in the test scenario 604, the degree of parallelism 723 in the test scenario 604, the measure 724 for the test scenario 604, and the precondition 725 that is prerequisite for the measure, and the priority 726 of the measure.

In the measure presentation processing, as shown in FIG. 9, the test program execution portion 18 determines, based on the test conduction result 701, whether there is a failed test, which is a failed pact test, among the conducted pact tests (step S301).

If there is a failed test (step S301: YES), the test program execution portion 18 determines, based on the measure management table 702, whether there is a measure corresponding to the failure pattern, which is a test pattern corresponding to the failed test (step S302).

If there is a measure (step S302: YES), the test program execution portion 18 presents this measure to the user (step S303), and ends the processing.

If there is no failed test (step S301: NO), or if there is no measure (step S302: NO), the test program execution portion 18 simply ends the processing.

The configuration and operation of the test support apparatus 1 described above are merely examples, and there is no limitation to this. For example, the state transition correspondence table management portion 14 may generate at least a part of the state transition correspondence table based on the source file of the program for providing the target service.

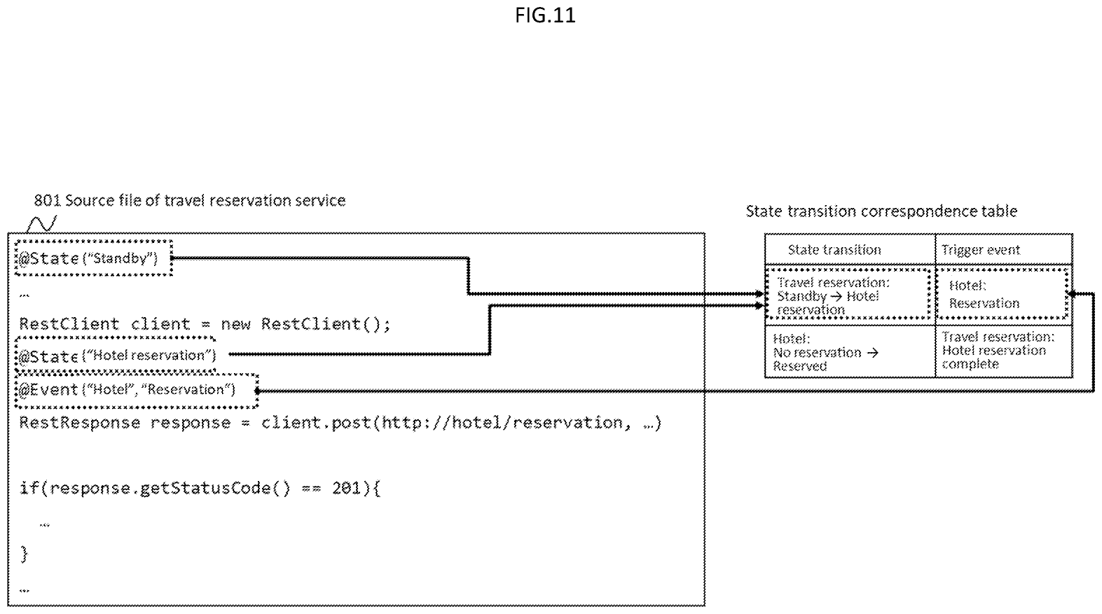

FIG. 11 is a diagram illustrating an example of processing for generating a state transition correspondence table. In the example of FIG. 11, the state transition correspondence table management portion 14 generates a state transition correspondence table 603 by analyzing the annotations included in the source file 801 of the program for providing the travel reservation service, which is the target service.

As described above, according to the present embodiment, based on the state transition table of each of the individual services and the state transition correspondence table that shows the correspondence relationship between a state transition in each individual service and the trigger event that triggers a state transition of another individual service caused by that state transition, the test scenario generation portion 15 generates a test scenario indicating the state transition pattern of the test target service and the state transition pattern of the coupling destination service that occurs in conjunction with that state transition pattern. The stateful pact generation portion 16 generates a stateful pact describing the response of the coupling destination service that takes into account the transition pattern of the coupling destination service. Based on the test scenario and the stateful pact, the test program generation portion 17 generates a pact test program, which is a program for conducting a test. As such, a pact test program can be generated by taking into account the state transition correspondence relationship between individual services using the state transition correspondence table, so that a test can be easily conducted even when the service is composed of multiple individual services.

Also, in the present embodiment, the test scenario generation portion 15 generates a test scenario indicating a state transition pattern of the test target service based on the state transition table of the test target service and adds the state transition pattern of the coupling destination service to the test scenario based on the state transition table of the coupling destination service and the state transition correspondence table. Thus, a test pattern can be generated more reliably by taking into account the correspondence relationship of state transitions between individual services.

Furthermore, in the present embodiment, the test scenario generation portion 15 generates an expanded test scenario by taking into account occurrence events such as abnormal events that may occur with state transitions. This allows a test to be conducted taking into account abnormal events.

Additionally, in the present embodiment, a measure for modifying the program for providing the test target service is presented based on the test conduction results, enabling efficient modification of the program.

Moreover, in the present embodiment, the state transition correspondence table management portion 14 generates at least a part of the state transition correspondence table based on the source file of the program for providing the target service. This allows for the reduction of the time and trouble of preparing the state transition correspondence table so that a test can be easily conducted.

The embodiments of the present disclosure described above are examples illustrative of the present disclosure and are not intended to limit the scope of the present disclosure only to those embodiments. Those skilled in the art can implement the present disclosure in various other forms without departing from the scope of the disclosure.

What is claimed is:

1. A test support apparatus for supporting a test regarding maintenance of data integrity in a predetermined service composed of a plurality of individual services, the test support apparatus comprising:
a scenario generation portion configured to generate, based on state transition information indicating a state transition that occurs in each of the plurality of individual services and correspondence information indicating a correspondence relationship between a state transition in each of the plurality of individual services and a trigger event that triggers a state transition of another of the individual services caused by the state transition, a test scenario indicating a target transition pattern that is a pattern of state transition of a target service that is any of the individual services, and a coupling destination transition pattern of state transition of a coupling destination service that is one of the individual services different from the target service that occur in conjunction with the target transition pattern;
a pact generation portion configured to generate, based on the test scenario, a stateful pact that is a pact describing a response of the coupling destination service that takes into account the coupling destination transition pattern; and
a program generation portion configured to generate, based on the test scenario and the stateful pact, a pact test program that is a program for conducting the test.

2. The test support apparatus according to claim 1, wherein the scenario generation portion is configured to generate, based on the state transition information of the target service, a test scenario indicating the target transition pattern, and add, based on the state transition information of the coupling destination service and the correspondence information, the coupling destination transition pattern to the test scenario.

3. The test support apparatus according to claim 1, wherein
the correspondence information further indicates a correspondence relationship between the state transition and an occurrence event that has a possibility of occurring in conjunction with the state transition, and
the scenario generation portion is configured to newly generate, as the test scenario, an expanded test scenario in which the target transition pattern in a situation, where the occurrence event occurs, is added to the test scenario.

4. The test supports apparatus according to claim 3, wherein the occurrence event is an abnormal event.

5. The test support apparatus according to claim 1, wherein the test support apparatus is configured to conduct the test by executing the program, and present, based on the test result, a measure regarding modification of a program for providing the target service.

6. The test support apparatus according to claim 1, further comprising a correspondence information management portion configured to generate at least part of the correspondence information by analyzing a source file of a program for providing the target service.

7. The test support apparatus according to claim 1, further comprising a correspondence information management portion configured to display a screen for inputting the correspondence information and receive the correspondence information via the screen.

8. A test support method for supporting a test regarding maintenance of data integrity in a predetermined service composed of a plurality of individual services, the test support method comprising, by a test support apparatus:
generating, on the basis of state transition information indicating a state transition that occurs in each of the plurality of individual services and correspondence information indicating a correspondence relationship between a state transition in each of the plurality of individual services and a trigger event that triggers a state transition of another of the individual services caused by the state transition, a test scenario indicating a target transition pattern that is a pattern of state transitions of a target service that is any of the plurality of individual services, and a coupling destination transition pattern of state transition of a coupling destination service that is one of the individual services different from the target service that occur in conjunction with the target transition pattern;
generating a stateful pact that is a pact that defines a response of the coupling destination service that takes into account the coupling destination transition pattern based on the test scenario; and
generating, based on the test scenario and the stateful pact, a pact test program that is a program for conducting the test.
